(19) United States
(12) Patent Application Publication
(10) Pub. No.: US 2008/0109309 A1
(43) Pub. Date: May 8, 2008

(54) Powered Print Advertisements, Product Packaging, and Trading Cards

(76) Inventors: Steven Landau, Oldsmar, FL (US); Richard Percival, Atascadero, CA (US)

Correspondence Address: PAUL, HASTINGS, JANOFSKY & WALKER LLP, 875 15th Street, NW, Washington, DC, 20005, US

(21) Appl. No.: 11/930,810

(22) Filed: Oct. 31, 2007

Related U.S. Application Data
(60) Provisional application No. 60/855,398, filed on Oct. 31, 2006.
(60) Provisional application No. 60/855,396, filed on Oct. 31, 2006.
(60) Provisional application No. 60/877,635, filed on Dec. 29, 2006.

(51) Int. Cl. G09F 27/00

(52) U.S. Cl. 705/14; 40/455; 340/540

(57) ABSTRACT

Compact powered systems are provided that include a substrate, a thin battery, an activation element, and an output device in electrical communication. The compact powered systems may be dynamic, powered print advertisements, product packaging, trading cards, printed ephemera or printed media that activate when subjected to an outside influence or stimulus. The output device is configured to, for example, display a number, graphic, or message, emit sound, cause movement or vibration, or transmit wireless signals in response to the stimulus.

This application claims the benefit of U.S. Provisional Application Nos. 60/855,398, filed Oct. 31, 2006; 60/855,396, filed Oct. 31, 2006; and 60/877,635, filed Dec. 29, 2006, which are all herein incorporated by reference in their entirety.

### BACKGROUND

1. Field of the Invention

The present invention relates generally to compact powered systems and, more particularly, to dynamic, powered print advertisements, product packaging, trading cards, and magazine covers that activate when viewed by a consumer, for example, activating an illumination device, displaying a number or graphic, emitting a sound, or causing movement.

2. Background of the Invention

Advertisers continually search for fresh and effective ways to capture the interest of consumers. Through direct mailings and publications such as newspapers and magazines, consumers are constantly bombarded with advertisements, each competing for the eyes of consumers. Thus, there remains a need for methods and devices that draw the attention of consumers or otherwise enhance the effect of a printed advertising message. Moreover, in meeting these needs, advertisers and publishers prefer inexpensive and versatile devices that are compact and can be easily inserted into printed documents, without disrupting typical high-speed printing and binding presses.

In addition, advertisers, such as manufacturers and retailers, prefer advertisements that form in a consumer's mind a strong connection between an advertisement and its associated product and/or brand, and draw the consumer into the store to purchase the product and other products.

With regard to product packaging, manufacturers desire effective ways of capturing the interest of consumers in retail locations. For example, manufacturers often provide special displays, bins, kiosks, and other free-standing point-of-purchase display devices to draw attention to their products. If their products are displayed on a shelf along with other competing products, however, the manufacturers must rely on the design of the product packaging to make their products stand out. To that end, manufacturers have typically favored bright, eye-catching graphics and specially shaped packages (e.g., other than box-shaped) that include ancillary products or product offers. A common example of such packaging is a cereal box that includes and displays promotional items, such as music and software CDs or miniature toy cars. These additional items can, however, add an undesirable level of complexity to the manufacturing and handling of the packaging.

There is a vast market for collectable cards. One of the most common forms of collectable or trading cards is the baseball card introduced by Topps in the 1950s. This genre of trading card has been enormously successful and has spawned countless other types of trading cards, including those for football, basketball, and hockey, among other professional sports, as well for cartoon characters, comic book characters, movie stars, etc. The Pokemon card series is just one example of a non-sports type trading card that, in recent times, has generated significant public interest, and revenue for the card manufacturer and brand owners.

In the 1970s the Kellogg company began distributing “3-D” cards in cereal boxes that gave a viewer of the card a sense of depth beyond what is normally provided by a photograph or artist's rendering—what is typically found on a conventional trading card. Although not nearly as popular as the conventional cardstock trading card, there was nevertheless a keen interest in this different kind of card, thereby signaling a demand by the public for different forms of trading cards.

The value, over time, of trading cards is set by the marketplace and may depend on several factors including, scarcity of a given card, the number of cards in a set, the popularity of a given team, event, character or person that is the subject of the card, and the availability of other similar cards or sets of cards. However, at the time of original purchase, a trading card is typically relatively inexpensive and, in many cases, designed to be affordable to children and young adults, in particular. Notwithstanding this general pricing approach, some trading cards are made as a “limited edition” and may therefore command an initially higher price.

Trading cards have taken on, over the years, a classic rectangular form and are typically made from relatively hard paper/cardboard cardstock or plastics, which maintain a certain degree of flexibility. Thus, any newly-marketed card will likely also have to have similar physical characteristics, or provide a different look and feel along with correspondingly different features or offerings.

Thus, there remains a need for methods and devices that attract the attention of shoppers or otherwise enhance the effect of a product or product package. Moreover, in meeting these needs, manufacturers prefer inexpensive and versatile devices that are compact and can be easily incorporated into existing product packages, such as cardboard boxes, without disrupting typical high-speed product packaging processes.

In addition, manufacturers prefer product packaging that forms in a consumer's mind a strong connection between the packaging and its associated product and/or brand, and draw the consumer over to the product.

### SUMMARY OF THE INVENTION

In accordance with an embodiment of the present invention, a powered device is provided that comprises a thin, flexible substrate having printed material thereon and a battery disposed in the substrate. An activation element is disposed in the substrate and in electrical communication with the battery and an output device is disposed in the substrate in electrical communication with the battery and the activation element. The battery, the activation element, and the output device are disposed in the substrate such that the substrate, the battery, the activation element, and the output device substantially maintain the thin and flexible qualities of the substrate. The activation element activates the output device in response to a contactless stimulus, and the output device produces a sound, graphic, vibration, or message upon activation.

In accordance with a further embodiment of the present invention, an advertisement system is provided that comprises a page of a publication having printed material thereon and a battery disposed in the page. The system further includes an activation element disposed in the page in electrical communication with the battery and an output device disposed in the page in electrical communication with the battery and the activation element. The activation element activates the output device in response to a stimulus, and the output device produces a sound, graphic, vibration, or message upon activation.

In accordance with a further embodiment of the present invention, an advertisement system is provided that comprises a page of a publication having printed material thereon and a battery disposed in the page. An activation element is disposed in the page and in electrical communication with the battery. An output device is also disposed in the page and in electrical communication with the battery and the activation element. The activation element is an RFID reader or Near Field Communication (NFC) emitter that activates the output device in response to a remote RFID tag being interrogated by an RFID reader or NFC emitter and, upon activation, produces a sound, graphic, vibration, or message, or transmits a wireless signal to a wireless receiver associated with the remote RFID tag.

In accordance with a further embodiment of the present invention, a powered trading card is provided that comprises a thin, flexible card substrate having printed material thereon and a battery disposed in the card substrate. An activation element is disposed in the card substrate and in electrical communication with the battery and an output device is disposed in the substrate and in electrical communication with the battery and the activation element. The battery, the activation element, and the output device are disposed in the card substrate such that the card substrate, the battery, the activation element, and the output device substantially maintain the thin and flexible form of the card substrate. The activation element activates the output device in response to a contactless stimulus, and the output device produces a sound, graphic, vibration, or message upon activation.

In accordance with a further embodiment of the present invention, a method of communicating an advertising message is provided in which a thin, flexible electronic display device is powered with a battery, and the battery is disposed in the electronic display device and maintains a substantially planar form. The electronic display device comprises an activation element and an output device and the activation element is subjected to a stimulus created by a consumer. The output device is activated in response to the stimulus, and produces a sound, graphic, vibration, or message upon activation in order to convey an advertising message to the consumer.

### BRIEF DESCRIPTION OF THE DRAWINGS

FIG. 1 is a schematic diagram of a powered print advertisement according to an embodiment of the present invention.

FIGS. 2-4 are schematic diagrams of advertising systems that use powered print advertisements in conjunction with radio frequency identification (RFID) or NFC devices, according to embodiments of the present invention.

FIG. 5 is a schematic diagram of a powered print advertisement having an embedded electrical connector, according to an embodiment of the present invention.

FIG. 6 is a schematic diagram of powered product packaging according to an embodiment of the present invention.

FIG. 7 is a schematic diagram of a powered trading card according to an embodiment of the present invention.

### DETAILED DESCRIPTION

In accordance with the present invention several embodiments of powered devices are provided. In each of the embodiments, various circuitry and circuitry elements are embedded or otherwise installed in one or more thin and flexible substrates in order to employ the inventive concept in a compact and convenient form. In some embodiments, it is desirable to produce a device that is thin enough to travel at U.S. Postal Service postcard special rates, which require a thickness of less than about 16 mils (0.016 in.) or 0.41 mm. In other embodiments, the thickness of the device is at least less than 0.25 inches, which is the maximum thickness for a machinable letter (per USPS Physical Standards for Machinable Letters and Cards), and will thus not be damaged or cause damage when subjected to a transport belt tension of 40 lb around an 11-inch diameter drum. In a further embodiment, the thickness of the device may be less than 50 mils or 1.27 mm, and may be formed to have the same thickness as that of a standard credit card, which is about 30 mils or about 0.76 mm.

In an embodiment of the powered printed publication of the present invention, a powered print advertisement is provided. The advertisement comprises a thin, flexible substrate (e.g., paper, thin cardboard stock, or plastic) having an embedded battery and electrical circuitry. Powered by the battery, the circuitry can, for example, display a light array, display alphanumeric characters or graphics, emit a sound, or cause movement (e.g., vibration). The powered print advertisement can be used on the cover or within paper publications, such as books, magazines, periodicals, journals, newspapers, comic books, retail and manufacturer circulars, coupons, and direct-to-consumer mailings. The battery and circuitry are incorporated directly into the substrate of the paper publication.

The electrical circuitry can be activated by any means suitable for a particular paper publication. For example, the circuitry can be activated by activation elements that respond to contactless stimuli, such as light sensors, audio sensors, motion sensors or detectors, or wireless sensors, or the circuitry can be activated by activation elements that respond to stimuli that make contact with the element or a portion of the element, such as mechanical switches, or buttons. With light, audio, and motion sensors, the powered advertisement would be activated when the appropriate stimulus is received. With wireless sensors using, for example, radio frequency identification (RFID), Bluetooth™, WiFi, Ultra Wide Band (UWB), infrared, or Near Field Communication (NFC) technology, the powered game playing card would be activated by the appropriate wireless signal. With mechanical switches, the powered advertisement can be, for example, activated by a user's pressing a button or multiple buttons, or by a switch that closes when the paper publication is opened (e.g., opening to the page of the advertisement or opening the envelope containing the direct mail advertisement). In some applications, a user-actuated mechanical switch may be preferred to save power and extend the shelf life of the powered advertisement. Once activated, the powered advertisement can produce sound, lights, and displays that are incorporated into the copy or graphical design of the advertisement, can interact with other objects using wireless technology, and can store data on embedded memory devices.

In an embodiment of the present invention, the circuitry and battery of a powered print advertisement is capable of being inserted into a sheet of paper or cardboard stock or sealed between sheets of paper, and may meet at least the flexibility requirements of ISO 7816. An appropriate flexible battery for such an apparatus is available from Solicore (Lakeland, Fla.), which produces batteries using polymer matrix electrolyte (PME). The batteries are ultra-thin, flexible, environmentally friendly, and safe, and preferably having the following characteristics:
low profile design—approximately 0.3 mm thick;
flexible and will not break or crack when bent or flexed;
conformable, in that the electrolyte can be a solid, non-compressible film, which can be shaped and formed into a variety of designs;
compatible with high speed printing and binding processes, and card manufacturing processes, and can survive hot lamination processes;
operable over a wide temperature range (−20° C. to +60° C.);
offer high ionic conductivity over a broad temperature range;
feature low self discharge rates (less than 1% per month);
provide high energy density (up to 300 Wh/l), thus offering maximum performance in smallest packages;
possess self connecting terminals;
are non-toxic, disposable, and environmentally friendly;
contain solid polymer electrolyte—no volatile liquids or gelling agents;
offer overall safety: with no out-gassing, swelling, or thermal runaway; no need for added safety devices; and pass UL requirements for crush test, drop test, and nail test; and
enjoy an inherently safe design which reduces the need for additional battery safety circuitry.

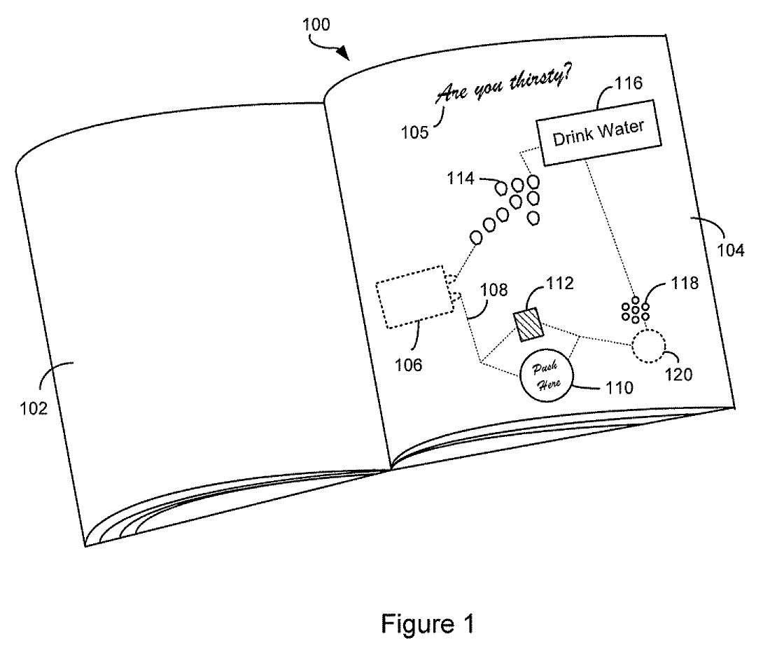

FIG. 1 illustrates a powered print advertisement 100 according to an embodiment of the present invention. In this example, advertisement 100 is a page of a printed publication 102, such as a magazine. Although shown as a full page, advertisement 100 could, of course, be only a portion of a page, or could be an insert card within the publication, such as those typically seen in magazines (e.g., for magazine subscriptions). As shown, advertisement 100 comprises a substrate 104, a battery 106, and circuitry 108. Substrate 104 can be paper or any other thin flexible material, on which is preferably printed an advertisement with copy and/or graphics 105 advertising a product and providing instructions, if necessary, for using the powered print advertisement 100. Battery 106 and circuitry 108 are embedded in substrate 104, as represented by the dashed lines. Circuitry 108 is embedded with control devices and circuitry, which may include, for example, a microprocessor, memory, clock, photovoltaic film for recharging, and any other necessary circuitry or devices. Circuitry 108 is controlled by at least one activation element, which may be in the form of a switch 110 or a sensor 112. Switch 110 can be, for example, a press button. Sensor 112 can respond to contactless stimuli and be, for example, a light sensor, an audio sensor, and/or a motion sensor. Circuitry 108 also includes one or more electronic output devices that are activated when circuitry 108 is powered, for example by triggering an activation element. For example, circuitry 108 can include an illumination device 114, a display 116, a speaker 118, and/or a vibrator 120.

In operation, powered print advertisement 100 activates in response to completion of circuitry 108, which provides or enables the drawing of power from battery 106 to the electronic output devices. Circuitry 108 is completed by sensor 112 and/or button 110. For example, a consumer might simply push button 110 to view the powered print advertisement 100. Alternatively, the advertisement 100 could automatically activate, in response to light (e.g., from opening publication 102 to the advertisement 100), to sound (e.g., from the consumer or from the moving leaves of the publication 102), to a wireless signal (e.g., from an RFID reader), or to motion (e.g., from the movement of publication 102). Sensor 102 could also comprise a mechanical switch that moves to a closed position when the publication 102 is opened to the advertisement 100. Examples of suitable mechanical switches are disclosed in, for example, U.S. Pat. Nos. 4,286,399 and 4,726,771, and U.S. Published Patent Application 2005/0227214, all of which are herein incorporated by reference.

Once triggered, circuitry 108, with its embedded control circuitry and/or devices, activates one or more electronic output devices 114, 116, 118, and 120. For example, circuitry 108 can light illumination device 114, display an alphanumeric message or graphic on display 116, play a sound, a message, or music through speaker 118 (e.g., a jingle associated with the advertised product), or activate vibrator 120. Illumination device 114 can comprise, for example, LED lights, incandescent lights, electroluminescent devices, or electronic ink display. Display 116 can comprise, for example, an LCD screen, an electroluminescent display (such as those produced by Philips Electronics of Amsterdam; Sharp of Osaka, Japan; or Planar Systems, Inc. of Beaverton, Oreg.), or an electronic ink display (such as those produced by E Ink of Cambridge, Mass., or Xerox of Palo Alto, Calif.). Speaker 118 can comprise, for example, a miniature speaker suitable for tight form factor applications. Vibrator 120 can comprise, for example, a miniature vibrator suitable for tight form factor applications, such as applications involving pagers and cellular telephones.

Display 116 can be used to disclose to the consumer additional information about advertisement 100. For example, display 116 can provide additional information about the product or manufacturer that is being advertised. Display 116 can also provide information regarding a discount on the product, for example, providing a discount or discount code to be provided when purchasing the product online or in the store.

Using electronic output devices 114, 116, 118, and 120, the present invention can enhance the impact of advertisement 100 and create a favorable, lasting impression on a consumer. Especially in the case of an automatically activated circuitry 108 (using sensor 112, for example), the added visual, audio, and tactile cues can attract the consumer's attention to the advertisement 100, prompting the consumer to read and view the advertisement 100.

In a further embodiment of the present invention, a powered print advertisement can be used in conjunction with wireless devices, such as RF devices, Bluetooth™ devices, UWB devices, WiFi devices, or NFC devices. For example, the thin, flexible batteries discussed above provide a reliable, safe, high performing form factor that enable implementations of semi-active and active RF tags. RF devices (e.g., tags, cards, labels, and fobs) use radio waves to communicate to a host device. On board battery power extends the range of this communication as well as the functionality of the device.

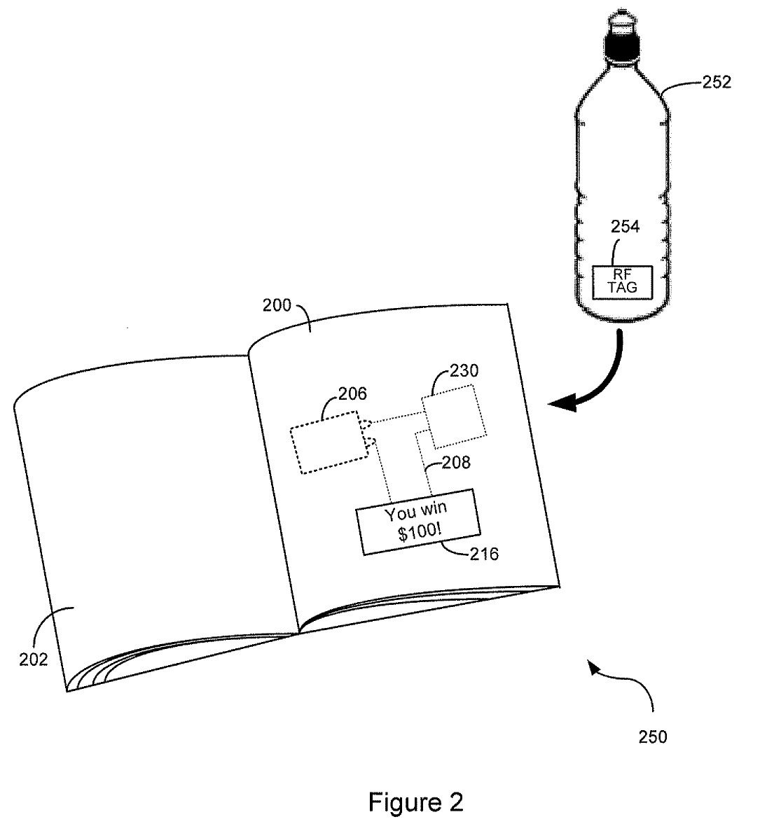

FIG. 2 illustrates an advertising system 250 that uses a powered print advertisement in conjunction with RF devices, according to an embodiment of the present invention. As shown, advertising system 250 includes a powered print advertisement 200 and a product 252 having an RF tag 254, which may have a unique or non-unique identifier or value stored therein. Advertisement 200 can be similar to advertisement 100 discussed above with reference to FIG. 1, except that advertisement 200 also includes an RF reader 230, which is powered by a battery 206 and controlled by circuitry 208 (with its embedded control circuitry and/or devices). In this example, advertisement 200 includes a display 216 as an electronic output device, but could, of course, include other electronic output devices, such as an illumination device, a speaker, or a vibrator as shown in FIG. 1.

RF reader 230 can be continually powered or can be activated by a switch or sensor as described above with reference to FIG. 1. In any case, when RF reader 230 is powered, product 254 is brought within the scanning range of RF reader 230. Depending on what RF reader 230 reads from RF tag 254, and on the logic embedded in circuitry 208, display 216 may display a corresponding alphanumeric message or graphic. In addition, circuitry 208 may activate other electronic output devices (not shown) on the advertisement that play congratulatory music, light illumination devices or electronic ink displays, and activate motion devices.

In one implementation, advertising system 250 can be used to deploy a contest or product sweepstakes. A consumer purchases the publication 202 to obtain an RF reader, which can then be used to scan advertised products that the consumer purchases. The RF reader 230 and circuitry 208 can determine which products are eligible for a prize based on the unique identification associated with each RF tag. Display 216 indicates whether the scanned product 252 is eligible for a prize, for example, displaying a winning message (e.g., “You win $100.”) and/or providing a code with which the prize can be redeemed. At the same time, circuitry 208 could also activate other electronic output devices (not shown) on the advertisement that play congratulatory music, light illumination devices or electronic ink displays, and activate motion devices. The consumer could then present the winning product at an appropriate location (e.g., mailing the product to the manufacturer or bringing the product to a retail location).

In a further implementation, each advertisement and product can be uniquely tagged such that only certain combinations of advertisements and products result in winning displays. Thus, a product 252 may win with one advertisement but not another. Such a configuration could encourage consumers to purchase additional product and publications. In another alternative, an output or display device may be installed on the product 252 that is activated in response to the interaction with the RF reader. The product 252 and the advertisement 200 may communicate with each other via wireless signals with respective transmitters and receivers, e.g., RF, Bluetooth, NFC, WiFi, UWB, sound, or infrared signals.

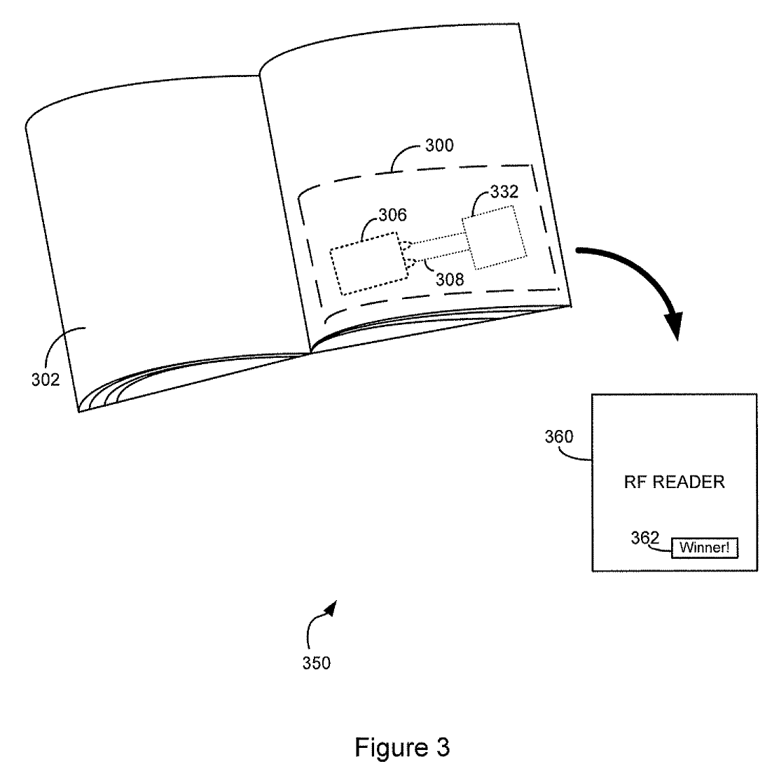

FIG. 3 illustrates another advertising system 350 that uses a powered print advertisement in conjunction with RF devices, according to another embodiment of the present invention. As shown, advertising system 350 includes a powered print advertisement 300 and an RF reader 360. Advertisement 300 includes a battery 306, circuitry 308 (with embedded control circuitry and/or devices), and a powered RF tag 332.

In this example, advertisement 300 is a coupon that can be clipped out of a publication 302. A consumer presents the advertisement to RF reader 360, which is located at a kiosk or cash register in a retail store, for example. RF reader 360 scans the RF tag 332 of advertisement 300 and provides the consumer with feedback on display 362, for example, indicating a particular benefit the advertisement 300 might afford (e.g., discount coupon, cash prize, or merchandise prize). Although shown only with an RF tag 332, advertisement 300 could, of course, include any of the additional components discussed above with reference to FIGS. 1 and 2. For example, advertisement 300 itself could include a display that instructs the consumer to take the advertisement 300 to where the RF reader is located.

In a further aspect of the invention, if the RF reader 360 determines that the advertisement 300 is a winning advertisement, the RF reader 360 could activate electronic output devices on the advertisement that play congratulatory music, light illumination devices or electronic ink displays, and activate motion devices. In this case, the RF reader 360 could be provided with a wireless transmitter and the advertisement 300 could include a wireless receiver, each of which may be separate components or integral with the RF components, so that the RF reader 360 may communicate with the advertisement 300 and activate an output device disposed thereon. The RF reader and the advertisement 300 may communicate with each other via wireless signals such as, for example, RF, Bluetooth, NFC, WiFi, UWB, sound or infrared signals.

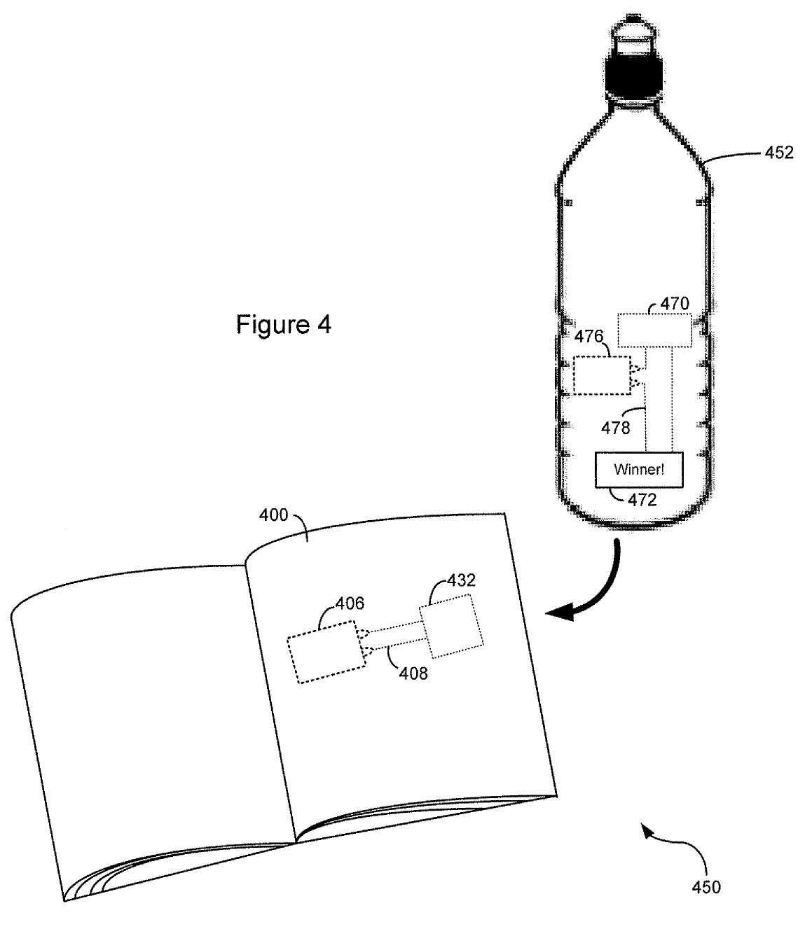

FIG. 4 illustrates another advertising system 450 that uses a powered print advertisement in conjunction with RF devices, according to another embodiment of the present invention. Advertising system 450 is similar to the system 250 shown in FIG. 2, except that the locations of the RF tag and RF reader are reversed. As shown, advertising system 450 includes a powered print advertisement 400 and a product 452. Product 452 has an RF reader 470 and a display 472, which are powered by a battery 476 and controlled by circuitry 478 (with its embedded control circuitry and/or devices). Advertisement 400 can be similar to advertisement 100 discussed above with reference to FIG. 1, except that advertisement 400 also includes an RF tag 432, which is powered by a battery 406 and controlled by circuitry 408 (with its embedded control circuitry and/or devices). Although not shown, advertisement 400 and product 452 could include additional electronic output devices, such as an illumination device, an electronic ink display, a speaker, or a vibrator as shown in FIG. 1.

In the implementation of FIG. 4, a consumer brings a product 452 and advertisement 400 together to determine what benefit, if any, the advertisement 400 and/or product 452 afford. In a further aspect of the invention, one or both of the circuitry 408 and 478 activate electronic output devices in response to a winning product and/or advertisement. In embodiments where the circuitry 408 includes and activates an electronic output device, a wireless signal transmitter may be provided on the product 452 and a wireless signal receiver may be provided on the advertisement 400 in order to transmit information for display or playback on the advertisement 400. In each of the embodiments shown in FIGS. 2-4 and/or described herein, any suitable configuration of wireless transmitters and receivers may be utilized to transfer encrypted or unencrypted relevant information between the item having the RF reader and the item having the RF tag in order to establish communication, as would be appreciated by those skilled in the art.

In a further aspect of the present invention, an RF-enabled powered printed advertisement can be used to provide customer specific information, which is based on a product the customer has already purchased. For example, a retailer selling accessories for digital music players made by a variety of manufacturers could use a powered printed advertisement that has an RF reader and associated embedded logic. In this manner, when a consumer brings his particular RF-tagged digital music player within the scanning range of the RF reader, the powered print advertisement determines the manufacturer and model number of the player, and presents accessories (e.g., software, downloads, and carrying cases) for that particular player in the display of the advertisement. The advertiser can also tailor discounts or promotions based on the particular digital music player, for example, displaying only those promotions applicable to the particular player.

In a further related aspect, a manufacturer can use RF-enabled powered printed advertisements to conduct a product recall campaign. For example, the manufacturer can distribute an advertisement containing a powered RF reader to customers by mail or by printed publications. The customer then brings his RF-tagged product within the scanning range of the RF reader included in the advertisement to determine the status of the recall with respect to the particular product and whether it is subject to the recall. If the scanned product is subject to the recall, the advertisement can change the display to provide instructions on how to respond to the recall. In this manner, the present invention makes it convenient for the customer to determine if the recall applies, reduces the potential for errors by the customer and/or manufacturer, and eliminates the need for the customer to contact the manufacturer by telephone or otherwise.

In a further aspect of the present invention, a print advertisement can include Solid State Flash Media and an embedded electrical connector, such as an embedded Universal Serial Bus (USB) connector or Universal Serial Bus (USB) configured substrates. In one implementation, the electrical connector is in communication with the circuitry of the powered print advertisement, enabling a user to connect the circuitry to a control device, such as a personal computer, and control the operation of the electronic output devices of the powered print advertisement. In another implementation, the electrical connector includes and/or connects to the Solid State Flash Media or a memory device embedded in the powered print advertisement, which together act as a flash memory drive (also referred to as USB thumb drives). The memory device may or may not be connected to the circuitry and may or may not be powered.

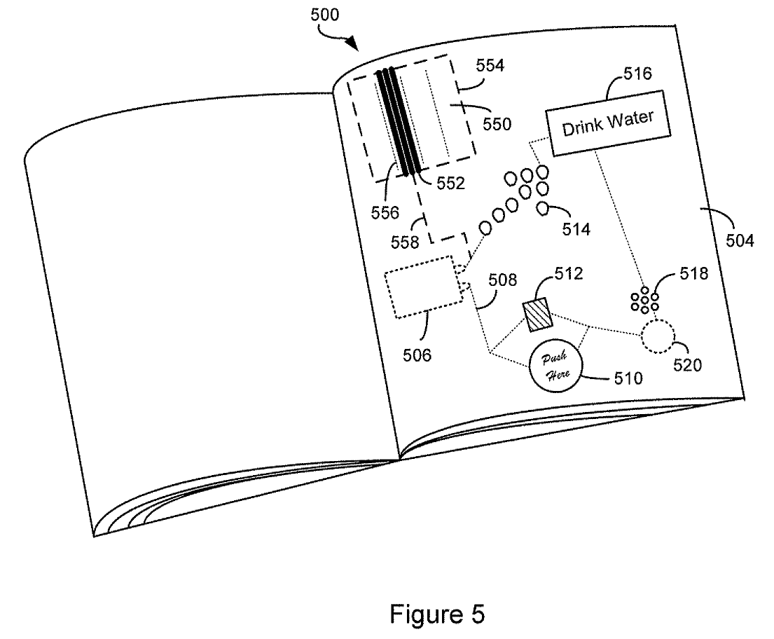

FIG. 5 illustrates a powered print advertisement 500 having an embedded electrical connector, according to an embodiment of the present invention. As shown, advertisement 500 is substantially similar to the print advertisement 100 of FIG. 1, and includes a substrate 504, a battery 506, circuitry 508, a switch 510, a sensor 512, an illumination device 514, a display 516, a speaker 518, and a vibrator 520, similar to the like components described above in reference to FIG. 1. In addition, powered print advertisement 500 includes an electrical connector 550 having conductive traces 552 in communication with circuitry 508. In this example, electrical connector 550 is flat and embedded within substrate 504, and includes means 554 for removing the electrical connector 550 from the substrate 504. The means for removing 554 could be, for example, perforations, pull tabs, pull strips, pull cords, or combinations thereof. Electrical connector 550 is preferably connected to circuitry 508 using a flexible conductor 558.

In this manner, electrical connector 550 can be removed from substrate 504, folded along lines 556 (which are, for example, scored or perforated) into a connector structure, and inserted into a compatible port. In one implementation, electrical connector 550 folds into the rectangular structure of a conventional USB connector and plugs into a USB port of a personal computer, such that the conductive traces 552 contact corresponding conductors of the USB port. With the electrical connector 550 connected, the personal computer can control the circuitry 508 and activate display 516 and other electronic output devices as desired.

Alternatively, electrical connector 550 also includes a memory device, such as Solid State Flash Media or a flash memory device. In one implementation, the combination electrical connector and memory device is an embedded USB flash drive. The memory device can include files and/or software that a user can download and use. The files could include, for example, digital media such as photographs, video, or music, which can be associated with the advertised service, product, or brand. The software could include, for example, demonstration versions of advertised software, or control software that enables a connected personal computer to control the display and electronic output devices of the printed advertisement. In one implementation, the files and/or software stored on the memory device or Solid State Flash Media enable a connected personal computer to unlock hidden functions or output, such as hidden images that are not available through the advertisement alone, but are displayable on display 516 once the personal computer is connected. In a further alternative embodiment, circuitry 508 enables the display of the contents of the embedded flash memory device on display 516.

In another alternative embodiment, the combination electrical connector, Solid State Flash Media, and memory device is a stand-alone part of the advertisement that is not connected to the embedded circuitry. The combination electrical connector and memory device can be removed from the advertisement and publication and carried and used apart from the printed advertisement. In this manner, the present invention can provide disposable embedded flash memory devices, which enable convenient distribution of digital content.

In another alternative embodiment, the advertisement, including a short range RF, Bluetooth, NFC, or UWB transmitting device, may be brought within range of a computer, entertainment center, TV, web appliance, or NFC-enabled mobile phone or PDA, suitably equipped with a standard receiver for the transmitting device, in order to pass content from the memory included in the advertisement and to display or play it, or to send an addressing signal (such as a URL) to cause the computer or web-enabled device to search for content specifically related to the unique identifier included in the advertisement. For example, an embodiment of the present invention provides a method for activating an information display system, such as a mobile phone, PDA, web appliance, or display device using information contained within a thin powered printed medium, to enhance, explain, demonstrate, teach, instruct, or entertain.

Although embodiments of the present invention relate to powered printed advertisements, one of ordinary skill in the art would appreciate that the present invention is applicable to other printed publications, including, for example, a book cover, a catalog cover, a limited edition fine-art print, or the actual content of a printed publication such as a comic book (e.g., even displaying animated content). Therefore, notwithstanding the particular benefits associated with powered printed advertisements, the present invention should be considered broadly applicable to any printed publication or (powered) medium.

A further embodiment of the powered printed publication of the present invention provides powered product packaging, one example of which was discussed above with respect to product 452 of FIG. 4. Like the powered printed advertisement embodiments discussed above, the product packaging comprises a thin, flexible substrate (e.g., paper, cardboard, or plastic) having an embedded battery and electrical circuitry. Powered by the battery, the circuitry can, for example, display a light array, display alphanumeric characters or graphics, emit a sound, cause movement (e.g., vibration), or transmit data. The powered product packaging can be incorporated into, for example, cardboard containers, plastic containers, and foil- and plastic-coated paper containers (e.g., juice boxes). The battery and circuitry are incorporated directly into the substrate of the packaging.

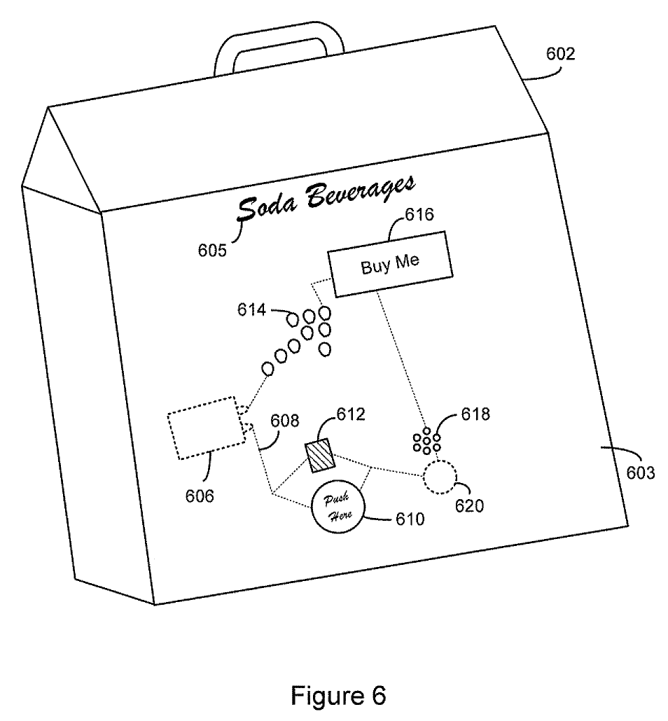

The embodiments discussed above with respect to powered printed advertisements can be applied equally to powered product packaging for the purpose of, for example, attracting consumer interest. As an example, FIG. 6 illustrates the powered printed publication of the present invention implemented on product packaging 602, according to an embodiment of the present invention. As shown, product packaging 602 is a container holding products for sale, which would typically be displayed on a retail store shelf. In this example, the front face 603 of the product packaging 602, which would preferably face the aisle of the store, contains the powered components of the present invention.

The substrate of the front face 603 of product packaging 602 can include a battery 606 and circuitry 608, and can be made of cardboard, plastic, or any other thin, flexible, and sturdy material suitable for product packaging. Product packaging 602 can have on its outer surface printed lettering, copy, and/or graphics 605 advertising the product it contains and providing instructions, if necessary, for using the powered components. Battery 606 and circuitry 608 are embedded in the substrate of front face 603, as represented by the dashed lines. Circuitry 608 is embedded with control devices and circuitry, which may include, for example, a microprocessor, memory, clock, photovoltaic film for recharging, and any other necessary circuitry or devices. Circuitry 608 is controlled by at least one of a switch 610 and a sensor 612. Switch 610 can be, for example, a press button (e.g., membrane switch). Sensor 612 can be, for example, a light sensor, an audio sensor, or a motion sensor or detector (e.g., sensing movement of the product packaging 602 or detecting movement of objects or persons in front of the product packaging 602). Circuitry 608 also includes one or more electronic output devices that are activated when circuitry 608 is powered. For example, circuitry 608 can include an illumination device 614, a display 616, a speaker 618, and/or a vibrator 620.

In operation, powered product packaging 602 activates in response to completion of circuitry 608, which provides or enables the drawing of power from battery 606 to the electronic output devices. Circuitry 608 is completed by sensor 612 and/or button 610. For example, a consumer might simply push button 610 to activate the powered product packaging 602. Alternatively, the packaging 602 could automatically activate, in response to light, to sound, to a wireless signal, or to motion, as discussed above with respect to a powered printed advertisement. In one implementation, product packaging 602 could be activated by a motion detecting sensor 612, which would sense movement of a shopper in front of the packaging 602 and would activate sounds and/or lights to attract the shopper's attention. In this manner, a group of powered product packaging stacked together on a shelf in a retail store would appear to come to life as the shopper passes the products, thereby commanding the shopper's attention, especially in comparison to other non-animated product packaging on the shelf. Sensor 102 could also comprise a mechanical switch that moves to a closed position when the product packaging 602 is opened.

Once closed, circuitry 608, with its embedded control circuitry and/or devices, activates one or more electronic output devices 614, 616, 618, and 620. For example, circuitry 608 can light illumination device 614, display an alphanumeric message or graphic on display 616, play a sound, a message, or music through speaker 618 (e.g., a jingle associated with the product being sold), or activate vibrator 620. Illumination device 614 can comprise, for example, LED lights, incandescent lights, electroluminescent devices, or electronic ink display. Display 616 can comprise, for example, an LCD screen, an electroluminescent display, or an electronic ink display, as described above with respect to powered print advertisements. Speaker 618 can comprise, for example, a miniature speaker suitable for tight form factor applications. Vibrator 620 can comprise, for example, a miniature vibrator suitable for tight form factor applications, such as applications involving pagers and cellular telephones.

The electronic output devices 614, 616, 618, and 620 can be used to disclose to the consumer information, advertisements, images, photos, animation, movie clips, or promotions related to the product contained in the packaging 602. For example, display 616 can provide an instant discount code to be provided when purchasing the product in the store. As another example, display 616 can provide recipes that use the product or suggest related products (e.g., suggesting salsa on a package of chips). As another example, display 616 could be used to show a portion of the contents of the product packaging (e.g., displaying an animated clip on a package containing a DVD movie or a video console game). Similarly, speaker 618 could be used to play a portion of the contents of the product packaging (e.g., playing an audio clip on a package containing a music CD). In a further embodiment, product packaging of the present invention can provide such digital content using electrical connectors, conductors, conductive traces, and/or memory devices as described above in reference to FIG. 5.

Using electronic output devices 614, 616, 618, and 620, the present invention can enhance the impact of the product packaging and create a favorable, lasting impression on a consumer. Especially in the case of an automatically activated circuitry 608 (using sensor 612, for example), added visual and audio cues can attract the consumer's attention to the product, prompting the consumer to inspect and purchase the product.

In a further embodiment of the present invention, similar to the powered printed advertisement embodiments discussed above (especially product 452 of FIG. 4), powered product packaging can be used in conjunction with wireless devices, such as RF devices, Bluetooth™ devices, WiFi device, UWB devices, or NFC devices. In this manner, the powered product packaging can activate in response to cooperating wireless devices. As an example, a product package containing an RF reader could detect the presence of a consumer carrying an RF-tagged credit card, and activate electronic output devices in response (e.g., offering tailored discounts to customers of that particular brand of credit card). As another example, a product package containing an RF reader could detect the presence of a related RF-tagged product and could activate electronic output devices in response. In this way, for example, a shopper who has already placed an RF-tagged jar of salsa in his shopping cart could pass a box of chips having an RF-reader in a panel of the box, in response to which the box could announce or display a discount for purchasing the chips and salsa together.

An RF-enabled product package could also interact with its own RF-enabled contents. For example, a box having an RF-reader in one of its panels could detect the different, individually RF-tagged products it contains, and could display the contents. In this way, for example, a box containing a variety of differently flavored soda cans could display the quantities and flavors of those different cans. In another example, a children's fast food meal box (e.g., a McDonald's Happy Meal™) having an RF reader could display information about the RF-tagged toy it contains.

In another embodiment, the powered product packaging could be a container for items purchased at a movie theater, such as candy boxes or popcorn buckets. The electronic output devices could provide promotions, advertisements, and information as described above, and could also provide functional benefits such as illuminating the immediate area around the consumer in a dark theater. In a further embodiment of the present invention, the powered product packaging could interact with the movie, for example, vibrating or producing sound or lights in response to sounds, lights, or wireless signals from the movie. For example, wireless transmitters arranged throughout the theater and synchronized with the movie could transmit wireless signals that are detected by wireless sensors on the powered product packaging, which then activate electronic components of the packaging to provide, for example, vibrations in the containers that the consumers are holding. In addition to movie theaters, this embodiment could be implemented with any live audience.

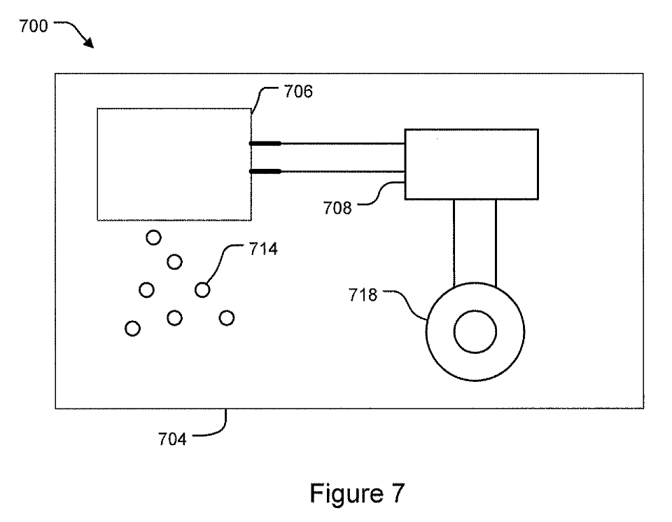

In accordance with a further embodiment of the present invention, an electrically powered trading or collectable card is provided. FIG. 7 depicts one possible implementation of such a trading card. The card 700 comprises a front face (not shown) and back face 704. Sandwiched between these two faces is a battery 706, an electronic circuit 708 (with appropriate memory), and at least one of light means 714 (e.g., LEDs, electronic ink display, and electroluminescent display (ELD) technology (from, Philips Electronics of Amsterdam; Sharp of Osaka, Japan; or Planar Systems, Inc. of Beaverton, Oreg.), e.g., for alphanumeric or graphic display) and a speaker 718. FIG. 7 shows an exemplary card 700 with its front face removed such that the internal components can be easily seen. Wires or conductive traces to each of the LEDs 714 are not shown, but those skilled in the art will appreciate that such conductors could be connected to the electronic circuit to be illuminated individually, or connected collectively such that they could be illuminated in unison, or some combination thereof. Similarly, if an alphanumeric or graphic (e.g., ELD) display is used, the circuit can be configured to drive the individual elements thereof in accordance with any desired design or sequence.

The speaker 718 can be configured to play songs, various sounds, or speech, as may be desired and as will be described more fully below.

As mentioned previously, trading cards have come to have an accepted form factor and are typically made from materials having flexibility as one characteristic. Still referring to FIG. 7, the battery of a powered card is typically the largest component. Accordingly, to maintain the flexibility properties of a common rectangular, flat, trading card, a flexible battery is preferably employed. Batteries suitable for this purpose are available from Solicore, Inc. (Lakeland, Fla.), as described above.

In accordance with an embodiment, the front and back faces of the trading card are made from cardstock and are adhered together using adhesives (not shown). The battery 706, electronic circuitry 708, and other components are all sufficiently thin that the trading card 700 can have the same “feel” as a conventional cardstock trading card.

In another embodiment of the present invention, rather than using cardstock between which the components are sandwiched, it is also possible to manufacture the trading card using plastic (e.g., PVC) sheeting, similar to that used for a credit card-sized ISO 7816 compliant card. Because such cards are significantly stiffer than cardstock, it may be desirable (but is purely optional) to employ thinner layers of plastic as the front and back face of the card to allow for flexibility characteristics that approach or are substantially identical to those of a conventional cardstock trading card.

Because the trading card of the present invention is powered, not only can the card include pictures, graphics, animations, movie clips, and the like on its front and back faces as is conventional, but the card can also generate sound, light and images/graphics as desired.

One application of such a powered trading card is to supply small portions of songs. A set of cards might together combine to play a larger portion (or the entirety) of a given song, or combine to play portions of different songs on a single album or other compilation. For example, each card in a set of cards might respectively include a portion of each song that was played at a particular concert. As a musical band travels from one city to the next, or has different play lists from one show to the next, powered trading card sets can be given away to maintain the “buzz” for the band. Card collectors can try to, e.g., collect all cards from a given show or all cards for all songs played at all the shows. Games and contests can be built around collecting some predetermined set of powered cards.

It is also envisioned that it may be desirable for reality television shows like American Idol™ to market sets of powered trading cards with musical snippets of each of the contestants for a given season. These types of cards can be branded with marks of the television show and producing network, and can be given away at promotional events, or sold in stores by themselves, or sold in combination with other products.

Considering again the venerable baseball trading card, a “powered” baseball trading card in accordance with the instant invention, might include a brief (2-10 second) recording of an audio clip of a home run hit by the player depicted on the card. This type of sound adds an entire new dimension to the convention baseball card. Obviously, those skilled in the art will appreciate that other sports and audio clips can be used, as desired.

As another example, a brief movie line or portion of dialogue that has become popular over time can be stored in the electronic circuit of a movie or movie star collectable card.

In addition to the use of a speaker to play any number of different types of sounds, the powered trading card of the present invention may also include illumination means in the form of LEDs, electronic ink display, or ELD technology. The LEDs can be made to flash in predetermined sequences or randomly, and/or be used simply to cause one's attention to be directed to a particular portion of the card, e.g., a baseball player statistic, a band's name, a brand of consumer item, etc.

Likewise, graphics can be made to light up around some portion of the card, to stream a short alphanumeric text message, or depict a short animated feature. ELD technology is particularly well-suited for this latter feature.

Another possible application is the distribution of individual cards of a “coded” set of cards. A collector would have to work with friends, colleagues, over the Internet, etc. in an effort to collect and then “decode” a coded message (whether in sound, light, or graphics).

In a preferred embodiment, both the sound and illumination means are operated simultaneously to bring to bear the full effect of the features of the powered trading card.

To save power, the powered trading card may be provided with a manual switch to enable the sound and/or display. In this way, the powered card shelf life can be substantially extended. The switch may instead be light sensitive, pressure sensitive, or wirelessly activated.

A manual switch may be utilized to enable the sound and/or display activation or may instead be light sensitive, pressure sensitive, or wirelessly activated.

To replenish power, the powered trading card may be provided with a thin film photovoltaic cell or cells to enable recharging of the embedded battery. A similar result can be achieved with an inductive loop. In these ways, the powered card shelf life can be substantially extended.

As mentioned above, the powered trading cards in accordance with the present invention may be given away free, given away as part of a related promotion, given as a gift with a purchase of an unrelated item, or made available for purchase on their own as products in their own right.

In accordance with an embodiment of the present invention, instructions adapted to be executed by a processor to perform a method are stored on a computer-readable medium. The computer-readable medium can be accessed by a processor suitable for executing instructions adapted to be executed. The terms “instructions configured to be executed” and “instructions to be executed” are meant to encompass any instructions that are ready to be executed in their present form (e.g., machine code) by a processor, or require further manipulation (e.g., compilation, decryption, or provided with an access code, etc.) to be ready to be executed by a processor.

In the context of this document, a “computer-readable medium” can be any means that can contain, store, communicate, propagate, or transport the program for use by or in connection with the instruction execution system, apparatus, or device. The computer readable medium can be, for example, but is not limited to, an electronic, magnetic, optical, electromagnetic, infrared, or semi-conductor system, apparatus, device, or propagation medium. More specific examples (a non-exhaustive list) of computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM). Note that the computer-readable medium could even be paper or another suitable medium upon which the program is printed, as the program can be electronically captured, via for instance, optical scanning of the paper or other medium, then compiled, interpreted, or otherwise processed in a suitable manner, if necessary, and then stored in a computer memory.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A powered device comprising:
a thin, flexible substrate having printed material thereon;
a battery disposed in the substrate;
an activation element disposed in the substrate and in electrical communication with the battery; and
an output device disposed in the substrate and in electrical communication with the battery and the activation element,
wherein the battery, the activation element, and the output device are disposed within the substrate such that the substrate, the battery, the activation element, and the output device substantially maintain the thin and flexible qualities of the substrate; and
wherein the activation element activates the output device in response to a contactless stimulus, and wherein the output device produces a sound, graphic, vibration, or message upon activation.

2. The powered device according to claim 1, wherein the substrate is a page in a printed publication.

3. The powered device according to claim 1, wherein the activation element is a light sensor.

4. The powered device according to claim 1, wherein the activation element is an audio sensor.

5. The powered device according to claim 1, wherein the activation element is a motion sensor.

6. The powered device according to claim 1, wherein the activation element is an RFID reader.

7. The powered device according to claim 1, wherein the activation element activates the output device in response to a wireless signal.

8. The powered device according to claim 1, further comprising a removable electrical connector disposed in the substrate.

9. The powered device according to claim 8, wherein the electrical connector comprises a memory device or embedded flash media for storing data and is readable by a personal computer.

10. The powered device according to claim 8, wherein the electrical connector comprises a memory device or embedded flash media for storing data and is in electrical communication with the output device, the powered printed medium configured to read data stored in the memory device and to display its contents on the output device.

11. The powered device according to claim 1, wherein the substrate is part of a product package and the output of the output device provides information related to a product contained in the product package.

12. The powered device according to claim 11, wherein the activation element is a wireless receiver and is configured to activate the output device in response to wireless signals received in a theater environment.

13. The powered device according to claim 1, wherein the activation element is a motion detecting sensor.

14. An advertisement system, comprising:
a page of a publication having printed material thereon;
a battery disposed in the page;
an activation element disposed in the page and in electrical communication with the battery; and
an output device disposed in the page and in electrical communication with the battery and the activation element,
wherein the activation element activates the output device in response to a stimulus, and wherein the output device produces a sound, graphic, vibration, message, or signal upon activation.

15. The advertisement system of claim 14, wherein the activation element is an RF or NFC reader and the stimulus is an RF tag, and wherein the output device produces a response that is determined by the value of a unique identification associated with the RF tag.

16. The advertisement system of claim 15, wherein the output device produces a response that indicates a contest winner when a particular RF tag is read by the RF or NFC reader, and the output device produces a response that indicates a contest loser when RF tags different from the particular RF tag are read by the RF or NFC reader.

17. The advertisement system of claim 15, wherein the RF tag is disposed on a product, and the output device produces a message indicating discounts, promotions, or accessories related to the product.

18. The advertisement system of claim 15, wherein the RF tag is disposed on a product, and the output device produces a message indicating the status of a recall related to the product.

19. The advertisement system of claim 14, further comprising an RF tag disposed in the page, wherein when the RF tag is read by a remote RF or NFC reader, the activation device receives a signal from the RF or NFC reader that is determined by the value of a unique identification associated with the RF tag and the output device produces a response based on the signal from the RF or NFC reader.

20. The advertisement system of claim 14, wherein the stimulus is a contactless stimulus.

21. The advertisement system of claim 14, further comprising a media content display device apart from the page of a publication, wherein the media content display device displays media content after receiving a transmission from the output device.

22. An advertisement system, comprising:
a page of a publication having printed material thereon;
a battery disposed in the page;
an activation element disposed in the page and in electrical communication with the battery; and
an output device disposed in the page and in electrical communication with the battery and the activation element,
wherein the activation element is an RF or NFC reader that activates the output device in response to a remote RF tag read by the RF or NFC reader, and
wherein the output device, upon activation, produces a sound, graphic, vibration, or message, or transmits a wireless signal to a wireless receiver associated with the remote RF tag.

23. The advertisement system of claim 22, wherein the output device is a first output device and the system further comprises a product, the remote RF tag and the wireless receiver being disposed on the product, and the product further comprising a second output device configured to vibrate, display a sound, graphic, or message based on the received wireless signal.

24. A powered trading card, comprising:
a thin, flexible card substrate having printed material thereon;
a battery disposed in the card substrate;
an activation element disposed in the card substrate and in electrical communication with the battery; and
an output device disposed in the substrate and in electrical communication with the battery and the activation element,
wherein the battery, the activation element, and the output device are disposed in the card substrate such that the card substrate, the battery, the activation element, and the output device substantially maintain the thin and flexible form of the card substrate; and
wherein the activation element activates the output device in response to a contactless stimulus, and wherein the output device produces a sound, graphic, vibration, or message upon activation.

25. A method of communicating an advertising message, comprising:
powering a thin, flexible electronic display device with a battery, the battery disposed in the electronic display device and maintaining the substantially planar form, the electronic display device comprising an activation element and an output device;
subjecting the activation element to a stimulus created by a consumer;
activating the output device in response to the stimulus, wherein the output device produces a sound, graphic, vibration, or message upon activation in order to convey an advertising message to the consumer.
